(19) United States
(12) Patent Application Publication
(10) Pub. No.: US 2012/0152079 A1
(43) Pub. Date: Jun. 21, 2012

(54) CUTTING APPARATUS

(75) Inventor: Yasuhisa KOSEKI, Shinagawa-ku (JP)

(73) Assignee: HIRATA CORPORATION, Shinagawa-ku (JP)

(21) Appl. No.: 13/300,915

(22) Filed: Nov. 21, 2011

(30) Foreign Application Priority Data
Dec. 17, 2010 (JP) 2010-282375

(51) Int. Cl. B26D 3/00

(52) U.S. Cl. 83/869

(57) ABSTRACT

This invention provides a cutting apparatus which holds a rectangular substrate covered by a cover sheet and cuts an edge portion of the cover sheet which protrudes from a periphery of the rectangular substrate. This cutting apparatus includes a periphery holding unit which includes a periphery mount portion on which a peripheral portion of the rectangular substrate is mounted and a periphery suction portion which chucks the periphery of the rectangular substrate, and is provided for each side of the rectangular substrate. The cutting apparatus also includes a movement guide unit which guides movement of the periphery holding units facing each other in directions to approach and separate from each other.

### BACKGROUND OF THE INVENTION

1. Field of the Invention

The present invention relates to a technique of cutting a cover sheet which covers a substrate.

2. Description of the Related Art

In some cases, a cover sheet covers a substrate such as a glass substrate or semiconductor wafer to protect its surface. For example, a solar cell module substrate uses a cover sheet to protect the light-receiving surface which receives a sunlight and to bind a plurality of members formed in a multilayer form which constitute the substrate. Edge portions of the cover sheet which protrude from the periphery of the substrate are not necessary, and hence it is necessary to cut them. Under the circumstances, apparatuses which cut the edge portions of cover sheets have been proposed (Japanese Patent Laid-Open No. 2001-320069 and Japanese Patent Publication No. 07-049189).

It is necessary for such an apparatus to hold a substrate so as not to cause positional shift during cutting of the edge portions of a cover sheet in order to properly cut the edge portions. Japanese Patent Laid-Open No. 2001-320069 discloses an apparatus including a plurality of vacuum suction heads which chuck the lower surface of a substrate and hold it. Japanese Patent Publication No. 07-049189 discloses an apparatus including a substrate clamp which clamps two side portions of a substrate to hold it.

As disclosed in Japanese Patent Publication No. 07-049189, it is difficult for a system which holds a substrate by clamping it to trim a cover sheet at the two side portions of a substrate against which the clamp abuts. In order to trim the cover sheet throughout the entire periphery of the substrate, it is necessary to change the way of holding the substrate. Therefore, the system which chucks the lower surface of a substrate as disclosed in Japanese Patent Laid-Open No. 2001-320069 is preferable in that it is not necessary to change the way of holding the substrate. On the other hand, swinging of the periphery of a substrate at the time of trimming a cover sheet will hinder smooth cutting. When a plurality of suction heads are arranged vertically and horizontally as disclosed in Japanese Patent Laid-Open No. 2001-320069, the suction heads are not properly arranged at the periphery of a substrate with a given size, resulting in insufficient holding of the substrate periphery. In addition, in order to cope with substrates with a plurality of sizes, many suction heads are required. When holding a substrate with a small size, some of the suction heads are not used for chucking and hence become wasteful suction heads.

### SUMMARY OF THE INVENTION

It is an object of the present invention to hold the peripheries of substrates more reliably in accordance with the substrate sizes and properly cut the edge portions of cover sheets.

According to the present invention, there is provided a cutting apparatus which holds a rectangular substrate covered by a cover sheet and cuts an edge portion of the cover sheet which protrudes from a periphery of the rectangular substrate, comprising a periphery holding unit which includes a periphery mount portion on which a peripheral portion of the rectangular substrate is mounted and a periphery suction portion which chucks the periphery of the rectangular substrate, and is provided for each side of the rectangular substrate, and a movement guide unit which guides movement of the periphery holding units facing each other in directions to approach and separate from each other.

Further features of the present invention will become apparent from the following description of exemplary embodiments (with reference to the attached drawings).

### BRIEF DESCRIPTION OF THE DRAWINGS

FIG. 1 is a plan view of a cutting apparatus A according to an embodiment of the present invention;

FIG. 2 is a front view of the cutting apparatus A;

FIG. 3 is a perspective view of a head unit H;

FIG. 4 is an exploded perspective view of the arrangement of part of the head unit H;

FIG. 5 is a sectional view of a driving unit 13;

FIG. 6A is a sectional view of a positioning/pressing unit 30;

FIG. 6B is a block diagram of a controller 300;

FIG. 7A is a sectional view of a periphery holding unit 60 taken along a line I-I in FIG. 1;

FIG. 7B is a sectional view of a collection unit 80 taken along a line II-II in FIG. 1;

FIG. 7C is a view showing the collection unit 80 when viewed from the end portion side;

FIG. 8 is a view for explaining a collection unit 80′;

FIG. 9 is a view for explaining a movement guide unit 90;

FIG. 10A is a plan view of an outer conveyor 100;

FIG. 10B is a side view of the outer conveyor 100;

FIG. 10C is a front view of the outer conveyor 100;

FIG. 10D is a view for explaining the operation of the outer conveyor 100;

FIG. 11 is a view for explaining transfer operation for a substrate 1 between a center holding unit 70 and the outer conveyor 100;

FIG. 12 is a view for explaining transfer operation for the substrate 1 between the center holding unit 70 and the outer conveyor 100;

FIG. 13A is a sectional view of the center holding unit 70 and inner conveyor 200 taken along a line III-III in FIG. 1;

FIGS. 13B and 13C are views for explaining the operation of the center holding unit 70 and inner conveyor 200;

FIGS. 14A and 14B are views for explaining teaching;

FIG. 15 is a view for explaining teaching;

FIGS. 16 and 17 are views for explaining positioning operation; and

FIGS. 18 to 21 are views for explaining trimming operation.

### DESCRIPTION OF THE EMBODIMENTS

### General Outline of Apparatus

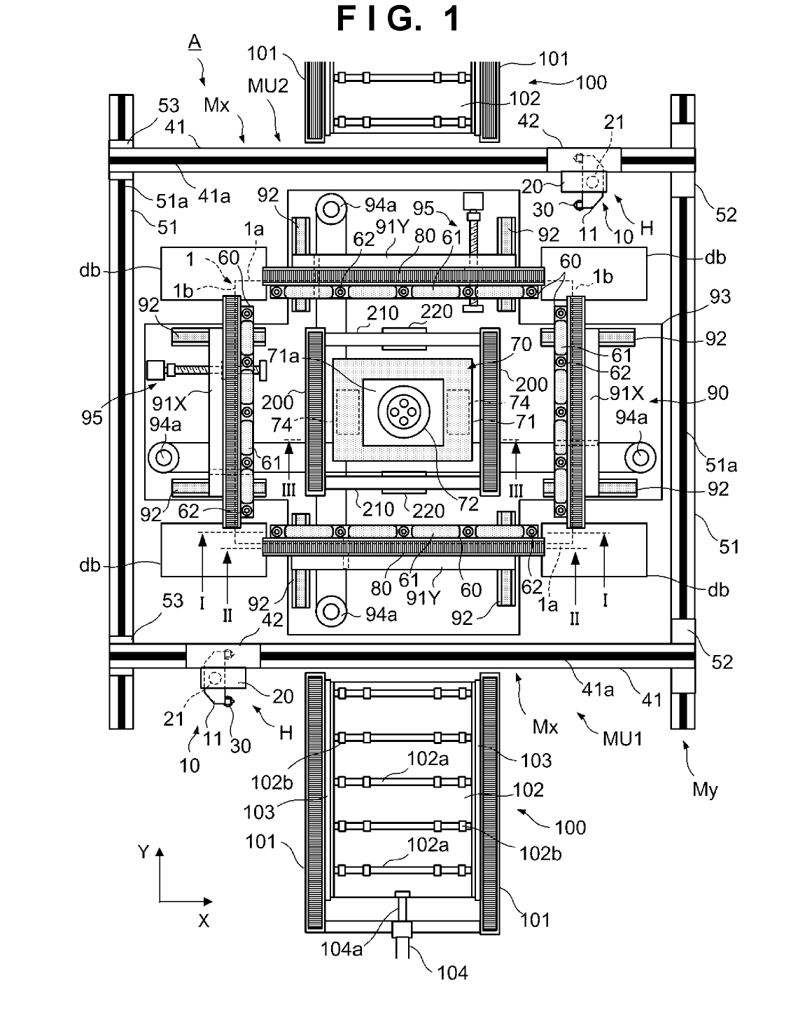

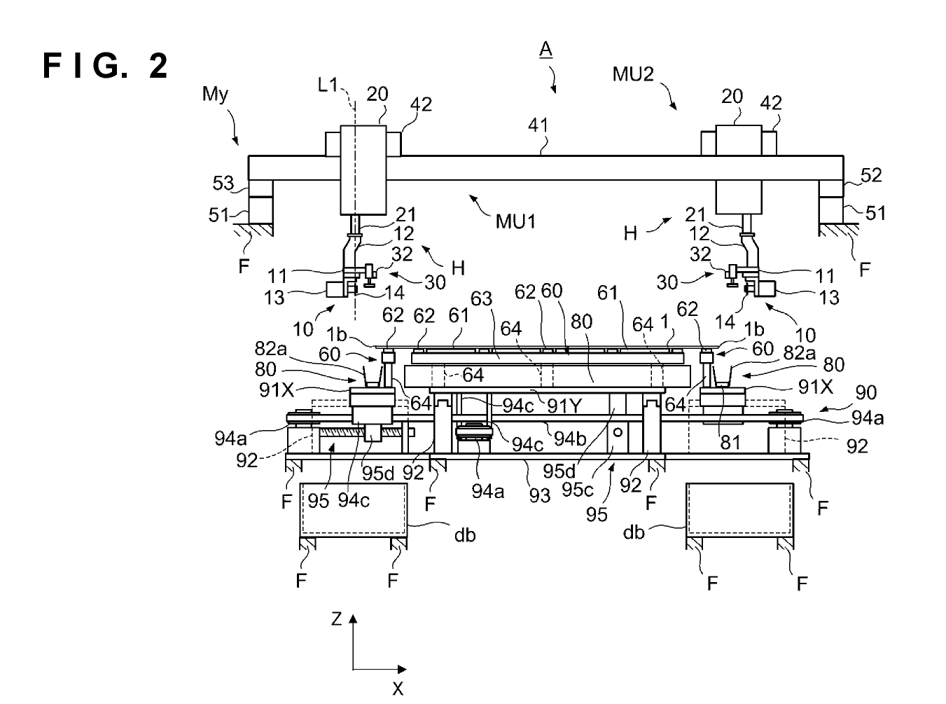

FIG. 1 is a plan view of a cutting apparatus A according to an embodiment of the present invention. FIG. 2 is a front view of the cutting apparatus A. Note that FIG. 2 omits the illustration of an outer conveyor 100. Referring to FIGS. 1 and 2, arrows X and Y represent horizontal directions which are two directions perpendicular to each other, and an arrow Z represents a vertical direction.

The cutting apparatus A includes moving units MU1 and MU2, a moving unit My which moves the moving units MU1 and MU2 in the Y direction, periphery holding units 60, a center holding unit 70, collection units 80, movement guide units 90, the outer conveyors 100, and inner conveyors 200. A frame F shown in a simplified form in FIG. 2 supports these components.

A substrate 1 is, for example, a glass plate, and is assumed to a rectangular substrate in this embodiment. The substrate 1 includes a first pair of sides 1a facing each other and a second pair of sides 1b facing each other. A cover sheet 2 (not shown in FIGS. 1 and 2) covers the substrate 1. As will be described later, the cutting apparatus A positions the substrate 1 such that the sides 1a become parallel to the X direction, and the sides 1b become parallel to the Y direction, holds the substrate 1 in a horizontal posture, and cuts the edge portions of the cover sheet 2 which protrude from the respective sides of the substrate 1.

<Moving Unit My>

The moving unit My moves the moving units MU1 and MU2 independently of each other in a direction (the Y direction in this embodiment) parallel to the sides 1b of the substrate 1. In this embodiment, the moving unit My includes a pair of rail portions 51 which are spaced apart from each other in the X direction and extend in the Y direction. The rail portions 51 have guide grooves 51a formed in the upper surfaces and extending in the Y direction.

One rail portion 51 is provided with two driving sliders 52 which can move on the rail portion 51 while being guided along the guide groove 51a. The other rail portion 51 is provided with two driven sliders 53 which can move on the rail portion 51 while being guided along the guide groove 51a. The driving sliders 52 and the driven sliders 53 are paired to provide two pairs of the driving sliders 52 and the driven sliders 53 in this embodiment.

Each driving slider 52 includes an independent driving source and independently travels by itself on the rail portion 51. As a mechanism for making the driving slider 52 travel by itself, for example, a ball screw mechanism can be used, which includes a ball screw provided on the rail portion 51 and a ball nut which threadably engages with the ball screw. Each driving slider 52 can include a ball nut and a rotation driving unit (for example, a hollow motor) which rotatably holds the ball nut and rotates it. Each driven slider 53 has no mechanism for making it travel by itself. However, a driving unit may be configured to make each driven slider 53 travel by itself, and to perform driving control to drive the driven sliders 53 in synchronism with the driving sliders 52.

A rail portion 41 of the moving unit MU1 or MU2 is laid across the driving slider 52 and driven slider 53 of each pair. The rail portion 41 extends in the X direction and moves in the Y direction as the driving slider 52 moves in the Y direction. This makes it possible to independently move the moving units MU1 and MU2 in the Y direction.

<Moving Units MU1 and MU2>

The moving units MU1 and MU2 respectively include support head units H and moving mechanisms Mx which move the head units H in a direction (the X direction in this embodiment) parallel to the sides 1a of the substrate 1. In the embodiment, in the moving units MU1 and MU2, the head units H and the moving mechanisms Mx respectively have the same arrangements. However, they may have different arrangements.

<Moving Mechanism Mx>

Each moving mechanism Mx includes the rail portion 41 extending in the X direction, with the two end portions being supported by the driving slider 52 and the driven slider 53. The rail portion 41 has a guide groove 41a formed in its upper surface so as to extend in the X direction. The rail portion 41 is provided with a driving slider 42 which can move on the rail portion 41 while being guided by the guide groove 41a. The driving slider 42 travels by itself on the rail portion 41 by using the same mechanism as that of the driving slider 52 described above. A pivoting/lifting unit 20 of the head unit H is fixed to the driving slider 42. In this manner, this embodiment can move the head units H in the X direction by causing the driving sliders 42 to move, and can move the head units H on an X-Y plane by causing the moving units My to move the moving units MU1 and MU2 in the Y direction.

Note that the cutting apparatus A includes sensor devices (not shown) for detecting the positions of the head units H in the X-Y direction. Such sensors include, for example, sensor devices for detecting the positions of the driving sliders 42 and 52. More specifically, if the driving sources for the driving sliders 42 and 52 are motors, such sensors include sensors (for example, encoders) which detect the amounts of rotation of the motors.

<Head Unit H>

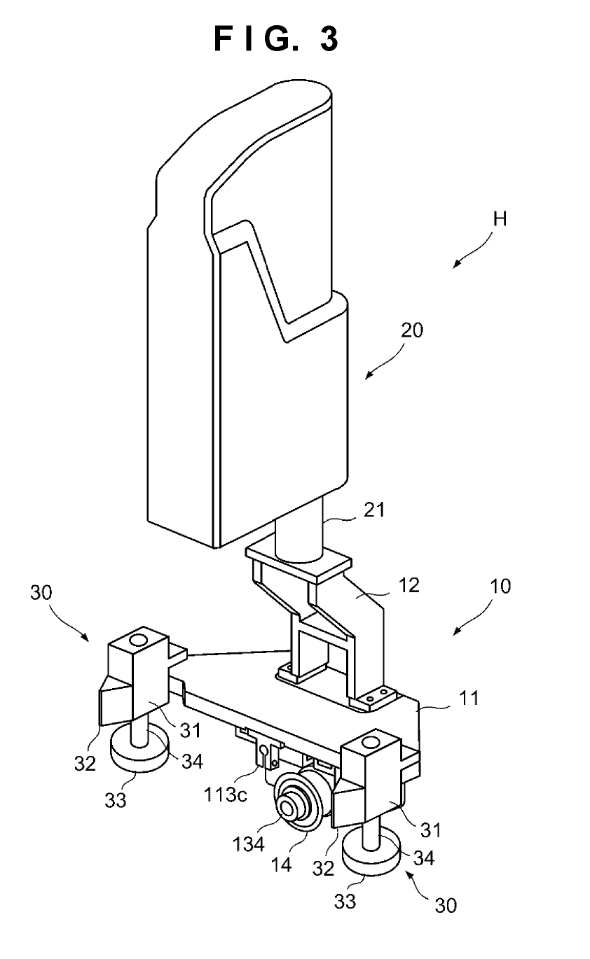

The arrangement of each head unit H will be described with reference to FIGS. 1 to 3. FIG. 3 is a perspective view of the head unit H. The head unit H includes a cutting unit 10, a positioning/pressing unit 30, and the pivoting/lifting unit 20 which causes the cutting unit 10 to pivot and move up and down. In this embodiment, since the positioning/pressing unit 30 is mounted on a main support portion 11 of the cutting unit 10, the pivoting/lifting unit 20 also causes the positioning/pressing unit 30 to pivot and move up and down, together with the cutting unit 10.

<Pivoting/Lifting Unit 20>

The pivoting/lifting unit 20 includes a shaft body 21 and a mechanism (not shown) which causes the shaft body 21 to rotate around its axis (a broken line L1 in FIG. 2) and move up and down. The shaft body 21 extends in a direction (the Z direction) parallel to the normal direction to the substrate surface of the substrate 1.

In this embodiment, the cutting unit 10 is coupled to the shaft body 21 so that rotating the shaft body 21 can make the cutting unit 10 pivot about the pivot center axis (the broken line L1 in FIG. 2) in the Z direction and maintain its pivot angle, and moving the shaft body 21 up and down can move the cutting unit 10 up and down in the Z direction.

By making the cutting unit 10 pivot and maintaining its pivot angle, the angle (intersection angle) between a plane (a vertical plane in the Z direction in this embodiment) perpendicular to the substrate surface of the substrate 1 including the sides 1a or 1b to be subjected to trimming and a plane (a vertical plane in the Z direction in the embodiment) formed by a disc blade 14, can be adjusted. Adjusting and maintaining this angle can make the disc blade 14 abut against the edges of the substrate 1 at a proper angle, thereby preventing the edges of the substrate 1 from being damaged at the time of cutting the cover sheet.

In addition, moving the cutting unit 10 up and down can adjust the cutting blade position (height position) of the disc blade 14 with respect to a plane (a vertical plane in the Z direction in this embodiment) perpendicular to a direction parallel to the normal direction to the substrate surface of the substrate 1 and a plane (a vertical plane in the Z direction in the embodiment) formed by the disc blade 14.

It is possible to adjust the direction and cutting blade position of the disc blade 14 in this manner. This makes it possible to cut a cover sheet along the sides 1a and 1b at an optimal inclination and cutting blade position in accordance with the type of cover sheet. Moving the positioning/pressing unit 30 up and down can position abutment members 32 of the positioning/pressing unit 30 and the substrate 1 in the Z direction at the time of positioning of the substrate 1, and then can position the disc blade 14 to the cutting position.

A known mechanism can be used as a mechanism which rotates and moves the shaft body 21 up and down. For example, a mechanism for rotating the shaft body 21 includes a combination of a driving source such as a motor and a mechanism such as a gear mechanism or a belt mechanism. As a mechanism for maintaining the rotational angle of the shaft body 21, if, for example, a servo motor is used as a driving source, the electromagnetic lock function of the servo motor can be used. Alternatively, it is possible to separately provide a lock mechanism for releasably restricting the rotation of the shaft body 21. A mechanism for moving the shaft body 21 up and down can include a combination of a driving source such as a motor and a mechanism such as a rack-pinion mechanism.

Note that each pivoting/lifting unit 20 includes a sensor device (not shown) for detecting the pivot angle (pivot position) and Z-direction position of the cutting unit 10. If the driving source which rotates and moves the shaft body 21 up and down is a motor, such a sensor includes a sensor (for example, an encoder) which detects the amount of rotation of the motor.

<Cutting Unit 10>

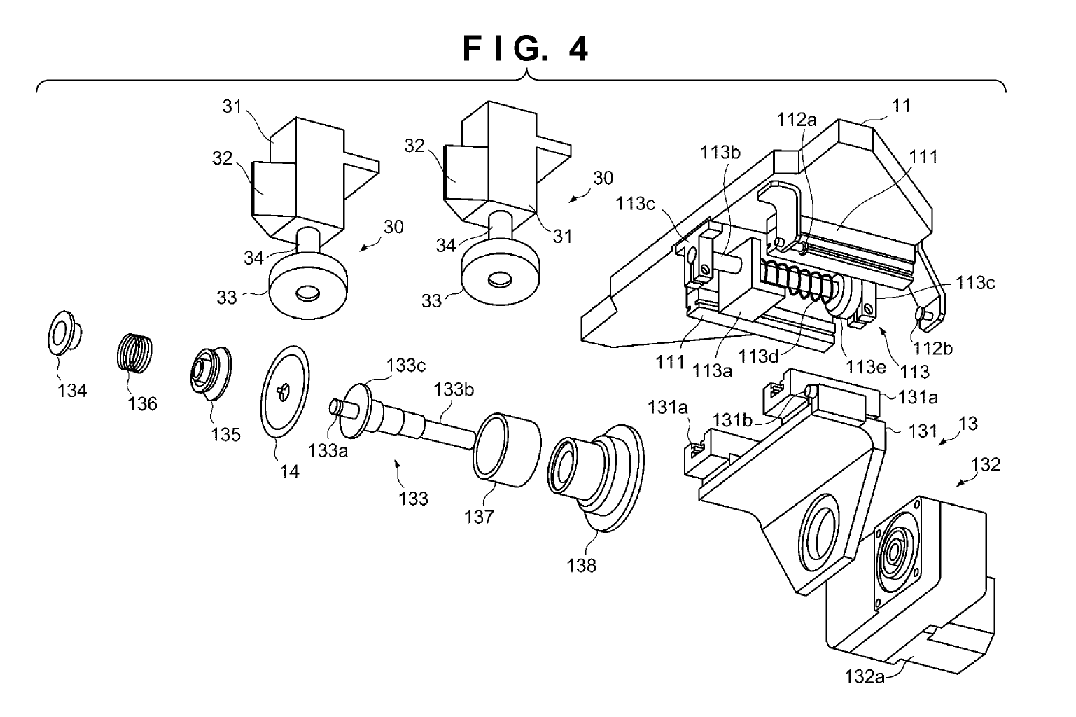

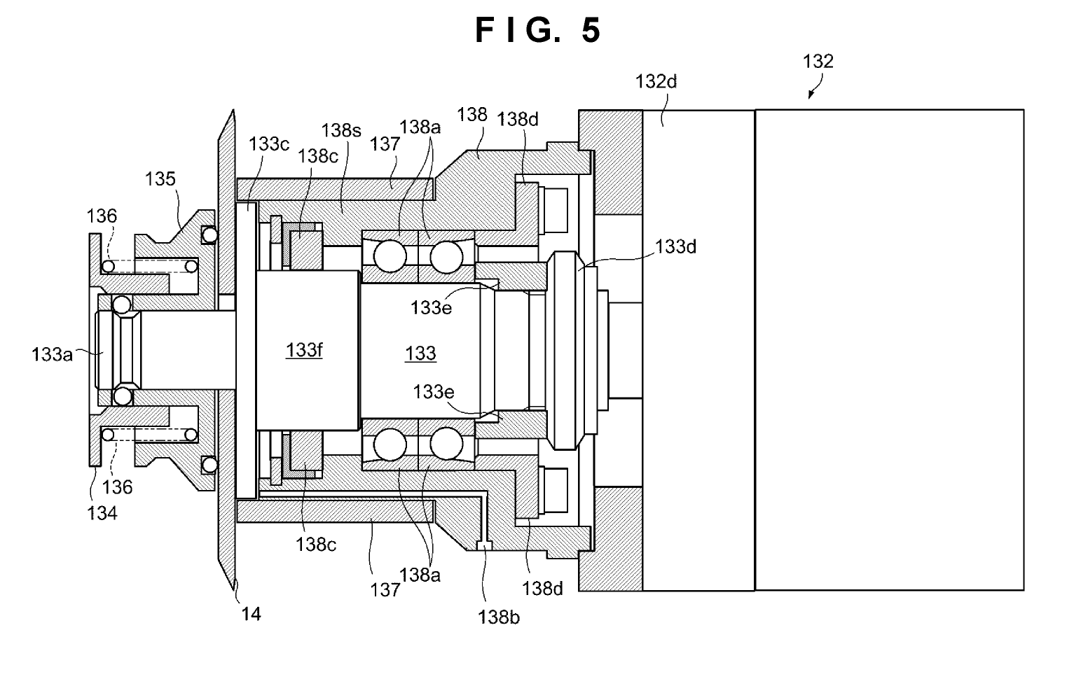

The cutting unit 10 will be described with reference to FIGS. 3 to 5. FIG. 4 is an exploded perspective view of the arrangement of part of the head unit H, in particular the arrangement of the main part of the cutting unit 10. FIG. 5 is a sectional view of a driving unit 13. This embodiment uses, as the cutting unit 10, the mechanism which cuts a cover sheet by rotating the disc blade 14. However, the present invention is not limited to this. For example, it is possible to use other types of cutting mechanisms such as a mechanism which cuts a cover sheet with a fixed blade.

The cutting unit 10 includes the main support portion 11, a coupling portion 12 which couples the shaft body 21 of the pivoting/lifting unit 20 to the main support portion 11, and a driving unit 13 which supports the disc blade 14 vertically with respect to a plane direction of the substrate 1 (a horizontal direction in this embodiment) and rotates the disc blade 14.

The driving unit 13 includes a support portion (slider) 131 having an almost L-shaped cross-section which has a vertical portion and a horizontal portion. A driving unit 132 is attached to the rear surface side (opposite to the side on which the disc blade 14 is located) of the vertical portion of the support portion 131. The driving unit 132 includes a motor 132a as a driving source and a reduction gear 132b which reduces the output of the motor 132a. A rear end portion 133b of a rotating shaft body 133 of the disc blade 14 is connected to the reduction gear 132b. As the motor 132a rotates, the rotating shaft body 133 rotates about its axis.

The rotating shaft body 133 has an attachment portion 133a, on its distal end portion, to which the disc blade 14 is attached. A collar-like disc blade abutment portion 133c is formed near the attachment portion 133a. The disc blade 14 with a key groove serving as a detent, a press member 135, and a stop member 134 are sequentially fitted on the attachment portion 133a. The stop member 134 is threadably engaged with the distal end of the attachment portion 133a. An elastic member 136 is inserted between the stop member 134 and the press member 135. In this embodiment, the elastic member 136 is a coil spring. The elastic member 136 biases the press member 135 toward the disc blade 14 to clamp the disc blade 14 between the disc blade abutment portion 133c and the press member 135, thereby suppressing the rotational vibration of the disc blade 14.

The rotating shaft body 133 extends in the horizontal direction. Attaching the disc blade 14 to the rotating shaft body 133 makes the plane formed by the disc blade 14 become perpendicular to a horizontal plane. The coupling position of the cutting unit 10 with respect to the pivoting/lifting unit 20 is adjusted such that the pivot center axis (the line L1 in FIG. 2: vertical direction) of the pivoting/lifting unit 20 is included in a plane parallel to a plane including the disc blade 14 (a vertical plane in this embodiment). It is possible to perform this adjustment by adjusting at least the shape of the coupling portion 12 or the coupling position between the coupling portion 12 and the main support portion 11. Making adjustment in this manner can position the disc blade 14 immediately below the pivot center axis of the pivoting/lifting unit 20. This leads to an advantage that when making the cutting unit 10 pivot by using the pivoting/lifting unit 20, it is easy to adjust the inclination of the plane formed by the disc blade 14 with respect to the sides 1a and 1b of the substrate 1.

The rotating shaft body 133 is axially supported by a ball bearing 138a. The ball bearing 138a is fitted in an inner peripheral wall of a tubular support member 138 on the rear end side. A fixing member 138d fastened with bolts prevents removal of the ball bearing 138a. A fixing ring 133d is screwed to the rear end portion side of the rotating shaft body 133. A fixing tubular body 133e is provided between the fixing ring 133d and the ball bearing 138a. The position of the fixing ring 133d is fixed in the axial direction of the rotating shaft body 133 by threadably engaging the fixing ring 133d with the rotating shaft body 133 and threading the fixing ring 133d toward the distal end side. This makes the fixing ring 133d abut against the fixing tubular body 133e, thus making the fixing tubular body 133e abut against the ball bearing 138a. This relatively positions the rotating shaft body 133 in the axial direction of the support member 138.

A seal portion 138c is formed inside the distal end side of a small-diameter portion 138s formed on the support member 138. The inner circumferential surface of the seal portion 138c is in tight contact with the outer circumferential surface of a first diameter portion 133f continuously formed from the disc blade abutment portion 133c of the rotating shaft body 133 to the rear end portion side. The seal portion 138c prevents cutting debris and the like of the cover sheet from entering the ball bearing 138a. In addition, an air path 138b is formed in the support member 138 so as to communicate with the gap between the disc blade abutment portion 133c and the support member 138. An air supply unit (not shown) supplies compressed air into the air path 138b. This compressed air is supplied to the space (gap) surrounded by the rotating shaft body 133, the support member 138, and the seal portion 138c. This increases the air pressure in the gap to generate an air current from the gap to the outside (atmospheric side), thereby further preventing the cutting debris and the like of the cover sheet from entering the ball bearing 138a.

A tubular body 137 is placed near the surface (rear surface) of the disc blade 14 on the rear end portion side with the disc blade 14 being a boundary, and surrounds the outer circumferential surface of the disc blade abutment portion 133c of the rotating shaft body 133. The tubular body 137 is loosely rotatably fitted on the small-diameter portion of the outer circumferential surface of the distal end portion of the support member 138. The surface of the disc blade 14 on the rear end side and the stepped portion of the small-diameter portion formed on the outer circumferential portion of the distal end portion of the support member 138 define the movement of the rotating shaft body 133 of the tubular body 137 in the axial direction. A portion cut from the cover sheet by the disc blade 14 may tangle around the rotating shaft body 133 in the form of a belt. In this embodiment, since the tubular body 137 is loosely rotatably provided on the rear surface portion of the disc blade 14, when a cut portion comes into contact with (rides on) the tubular body 137, the tubular body 137 loosely rotates. This can prevent the cut portion from tangling around the tubular body 137.

The retracting mechanism of the driving unit 13 will be described next with reference to FIG. 4. A pair of slide members 131a are fixed on the upper surface of the horizontal portion of the support portion 131. A pair of rail members 111 which guide the slide members 131a are fixed on the lower surface of the main support portion 11. The rail members 111 and the slide members 131a extend in the rotation center line direction (the axial direction of the rotating shaft body 133) of the disc blade 14. The driving unit 13 is supported on the main support portion 11 through the support portion 131 and is guided by the rail members 111 to retractably move in the rotation center line direction of the disc blade 14.

The main support portion 11 is provided with stopper portions 112a and 112b. The stopper portion 112a abuts against a stopper portion 131b provided on the support portion 131, and the stopper portion 112b abuts against the rear surface of the support portion 131, thereby restricting the moving range of the driving unit 13, that is, the disc blade 14.

The lower surface of the main support portion 11 is provided with a biasing portion 113 which always biases the driving unit 13 in the direction to approach the substrate 1. The biasing portion 113 includes a transfer member 113a, a support shaft 113b, support portions 113c, an elastic member 113d, and a reception member 113e. The support shaft 113b extends parallel to the rail members 111. The two end portions of the support shaft 113b are supported by the support portions 113c. The transfer member 113a is an L-shaped member having a hole through which the support shaft 113b extends, and can move while being guided by the support shaft 113b. The support portion 131 of the driving unit 13 is coupled to the lower portion of the transfer member 113a.

The support shaft 113b extends through the reception member 113e. The elastic member 113d is interposed between the transfer member 113a and the reception member 113e while the support shaft 113b extends through the elastic member 113d. The elastic member 113d is a coil spring in this embodiment, which is a compression coil spring exerting a biasing force in the direction to separate the transfer member 113a and the reception member 113e from each other. The biasing force of the elastic member 113d is transferred to the support portion 131 via the transfer member 113a.

The elastic member 113d always biases the driving unit 13 (disc blade 14) coupled to the transfer member 113a in the direction to approach the substrate 1. This can make the disc blade 14 stably abut against the sides 1a and 1b of the substrate 1 at the time of cutting the cover sheet, thereby implementing smooth cutting of the cover sheet. It is also possible to cut the cover sheet while absorbing, if any, the difference between a predetermined cutting position and an actually positioned cutting position on the substrate as long as the difference falls within the biasing stroke range of the elastic member 113d. When the apparatus starts cutting the cover sheet from a midway position on the sides 1a and 1b of the substrate 1, even if the disc blade 14 abuts against the sides 1a and 1b, the disc blade 14 is pressed in a direction opposite to the direction to approach the substrate 1, and the elastic member 113d deflects to absorb the shock produced when the disc blade 14 abuts against the sides 1a and 1b.

<Positioning/Pressing Unit 30>

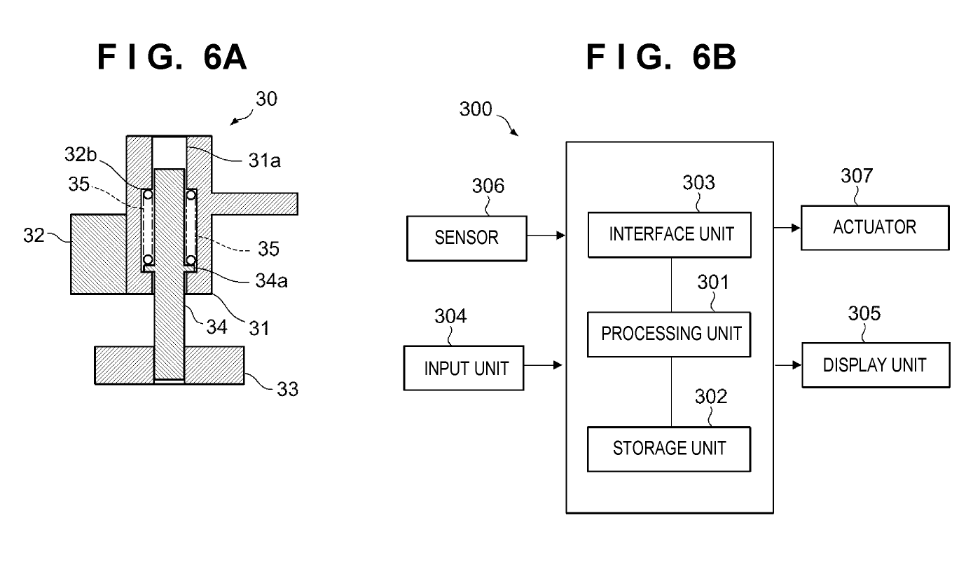

The positioning/pressing unit 30 will be described with reference to FIGS. 1 to 4 and 6A, in particular FIG. 6A. FIG. 6A is a sectional view of the positioning/pressing unit 30. Each positioning/pressing unit 30 includes a main body portion 31 fixed to the main support portion 11 of the cutting unit 10. The abutment member 32 is fixed to the main body portion 31. The positioning/pressing unit 30 is positioned and attached to the main support portion 11 such that the abutment member 32 is located closer to the substrate 1 than the disc blade 14.

The abutment member 32 is a member which abuts against one side (the side 1a in this embodiment) of the substrate 1 to position the substrate 1. Although the shape of the abutment member 32 is not specifically limited, it has an almost triangular horizontal cross-section (a vertical cross-section in FIG. 6A), and has its distal end abutting against the side 1a of the substrate 1.

In this embodiment, one head unit H includes two positioning/pressing units 30, and has the two abutment members 32 spaced apart from each other in the horizontal direction. At the time of positioning, the two abutment members 32, which are spaced apart from each other in the horizontal direction, abut against one side of the substrate 1 to position the substrate 1. However, one head unit H may include one abutment member 32. In this case, a portion of the abutment member which abuts against one side of the substrate 1 preferably has a planar shape having a predetermined width in the longitudinal direction of the side.

The main body portion 31 has a hole 31a extending through it in the Z direction. A shaft 34 is inserted in the hole 31a. A large-diameter portion 32b is formed in the middle of the hole 31a. An elastic member 35 is accommodated in the large-diameter portion 32b. In this embodiment, the elastic member 35 is a coil spring. A collar portion 34a is formed on the middle portion of the shaft 34. The collar portion 34a is accommodated in the large-diameter portion 32b, and is always biased downward by the elastic member 35.

A press member 33 is fixed to the lower end portion of the shaft 34. The press member 33 is a member for pressing an end portion of the substrate 1 against the upper surface of the holding unit 60 from the surface side (upper surface side) of the substrate 1. For example, the press member 33 is a plastic member having a smooth lower surface. In this embodiment, the press member 33 gently presses an end portion of the substrate 1 to press it against suction portions 62 arranged on each holding unit 60 (to be described later), thereby reliably chucking and holding the substrate 1. This can prevent a chucking error due to a space which is produced between a given suction portion and the substrate 1 when it has slight distortion.

As will be described later, before cutting a cover sheet, each press member 33 is placed above the substrate 1, and the pivoting/lifting unit 20 moves the cutting unit 10 downward to press the press member 33 against the surface of the substrate 1. At this time, the substrate 1 exerts a reaction force on the press member 33 and the shaft 34 so as to move them upward. However, with the biasing force of the elastic member 35, the press member 33 presses the substrate 1 against the holding unit 60 with an appropriate pressing force.

Note that in this embodiment, the positioning unit for the substrate 1 and the surface pressing unit for the substrate 1 are integrated into the single positioning/pressing unit 30. However, they may be implemented as separate units.

<Periphery Holding Unit 60>

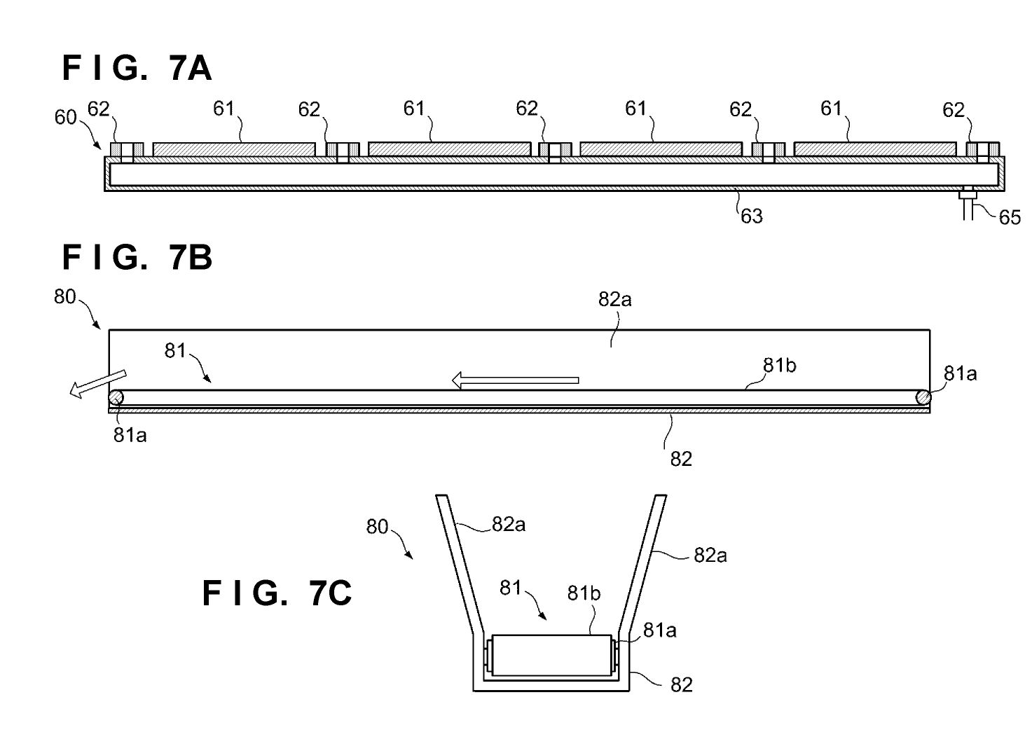

The periphery holding unit 60 will be described with reference to FIGS. 1, 2, and 7A. FIG. 7A is a sectional view of the periphery holding unit 60 taken along a line I-I in FIG. 1. The periphery holding unit 60 is provided for each of the sides 1a and 1b of the substrate 1. A total of four periphery holding units are provided. Each periphery holding unit 60 includes periphery mount portions 61 on which a peripheral portion (edge area) of the substrate 1 is mounted, periphery suction portions 62 which chuck the periphery of the substrate 1, and a support member 63.

The support member 63 is a tubular member having a square cylindrical shape extending in the horizontal direction. The support members 63 of the two periphery holding units 60, of the four periphery holding units 60, which correspond to the sides 1a of the substrate 1 extend in the X direction. The support members 63 of the two periphery holding units 60 corresponding to the sides 1b of the substrate 1 extend in the Y direction. Each support member 63 supports the substrate 1 horizontally from below through the periphery mount portions 61 and the periphery suction portions 62. Supporting the periphery (the respective side portions) of the substrate 1 horizontally, in particular, allows to suitably trim the cover sheet 2.

The periphery suction portions 62 are vacuum suction pads, which communicate with the internal spaces of the support members 63. The support member 63 is connected to vacuum pumps (not shown) through pipes 65. Evacuating the support members 63 by actuating the vacuum pumps will cause the periphery suction portions 62 to chuck and hold the peripheral portions of the substrate 1. When the periphery suction portions 62 chuck the peripheral portions of the substrate 1, the periphery mount portions 61 attract the peripheral portions of the substrate 1 with the suction force of the periphery suction portions 62. As a consequence, the peripheral portions are firmly attached to the periphery mount portions 61. This makes the peripheral portions along the sides 1a and 1b of the substrate 1 be reliably held on the periphery mount portions 61. This can prevent the substrate periphery from swinging (moving) or rattling at the time of trimming the cover sheet 2. As a consequence, it is possible to properly cut the edge portions of the cover sheet 2.

This embodiment uses the support members 63 as not only members for supporting the substrate 1 but also air passages which suck air from the periphery suction portions 62. This structure helps to reduce the number of components. The periphery suction portions 62 are arranged on each support member 63 at equal intervals along the longitudinal direction (extending direction). This further uniformly increases the suction force for the peripheral portions of the substrate 1.

The periphery mount portions 61 are portions on which upper surfaces of the peripheral portions of the substrate 1 are mounted, and may be integrally formed with the support members 63 or may be separately formed. In this embodiment, the periphery mount portions 61 are separately formed from the support members 63 and fixed to them. In the embodiment, the periphery mount portions 61 and the periphery suction portions 62 are alternately arranged. This makes it possible to tightly attach the entire areas of the peripheral portions of the substrate 1 to the periphery mount portions 61 with a uniform suction force.

<Collection Unit 80>

The collection unit 80 will be described with reference to FIGS. 1, 2, 7B, and 7C. FIG. 7B is a sectional view of the collection unit 80 taken along a line II-II in FIG. 1. FIG. 7C is a view showing the collection unit 80 when viewed from its end portion side.

The collection units 80 are respectively arranged outside the periphery holding units 60. That is, a total of four collection units 80 are provided. The collection units 80 are devices for collecting the cut edge portions of the cover sheet 2. This can prevent the cut edge portions of the cover sheet 2 from scattering.

In this embodiment, the collection units 80 include conveyors 81 and collection guide members 82 which extend in the directions along the sides 1a and 1b of the substrate 1 (that is, the X and Y directions) along the adjacent periphery holding units 60.

Each collection guide member 82 having a U-shaped cross-section includes, on the two side portions, guide portions 82a which tilt so as to gradually increase the opening upward. Each collection guide member 82 is provided around the conveyor 81 so as to guide the falling edge portions cut from the cover sheet 2 to the conveyor 81. The upper end of the guide portion 82a, of the two guide portions 82a, which is located more inwardly (on the periphery holding unit 60 side) is preferably located below the upper surface of the periphery mount portion 61 as in this embodiment, and is more preferably located more inwardly than the outer edge of the periphery mount portion 61 (on the center holding unit 70 side). This can improve the ability to capture the falling edge portions cut from the cover sheet 2.

Each conveyor 81 is a belt conveyor which is provided on the bottom portion of the collection guide member 82, and includes a pair of pulleys 81a and an endless belt 81b wound around the pair of pulleys 81a. One of the pair of pulleys 81a is rotated and driven by a driving unit (not shown) such as a motor. This makes the endless belt 81b travel.

When the edge portions of the cover sheet 2 which are cut by the cutting units 10 fall on the endless belt 81b, the endless belts 81b travel to convey the edge portions in the directions along the sides 1a and 1b of the substrate 1 (that is, the X and Y directions), and the edge portions fall downward from end portions of the collection units 80, as indicated by the arrow in FIG. 7B.

As shown in FIGS. 1 and 2, a collection box db is placed below an end portion of the collection unit 80, and edge portions falling downward from the end portion of the collection unit 80 is stored in the collection box db. In this manner, cut edge portions can be collected. Note that the endless belt 81b may always or periodically travel during trimming operation.

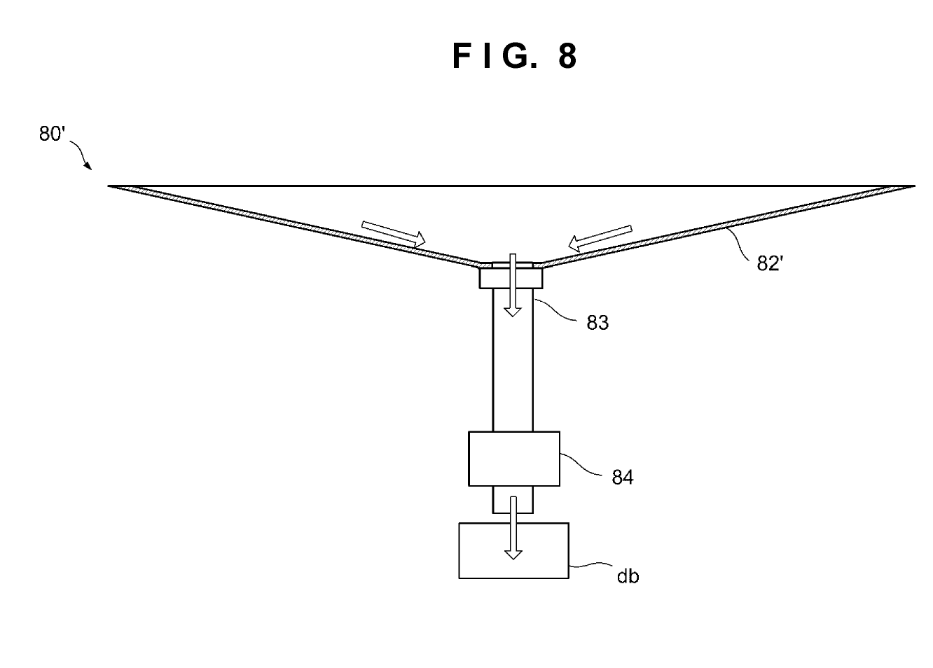

Note that edge portions may be collected by suction conveyance. FIG. 8 is a view for explaining a collection unit 80′ as another example, which corresponds to the sectional view of FIG. 7B. In the example shown in FIG. 7B, a collection guide member 82′ tilts toward the central portion in the longitudinal direction as a whole to form a funnel shape, and receives and collects the falling edge portions cut from the cover sheet 2. A suction device 84 is connected to the central portion of the collection guide member 82′ in the longitudinal direction through a pipe 83. The suction device 84 includes, for example, a vacuum pump, and chucks the edge portions cut in the collection guide member 82′, and discharges them to the collection box db.

<Movement Guide Unit 90>

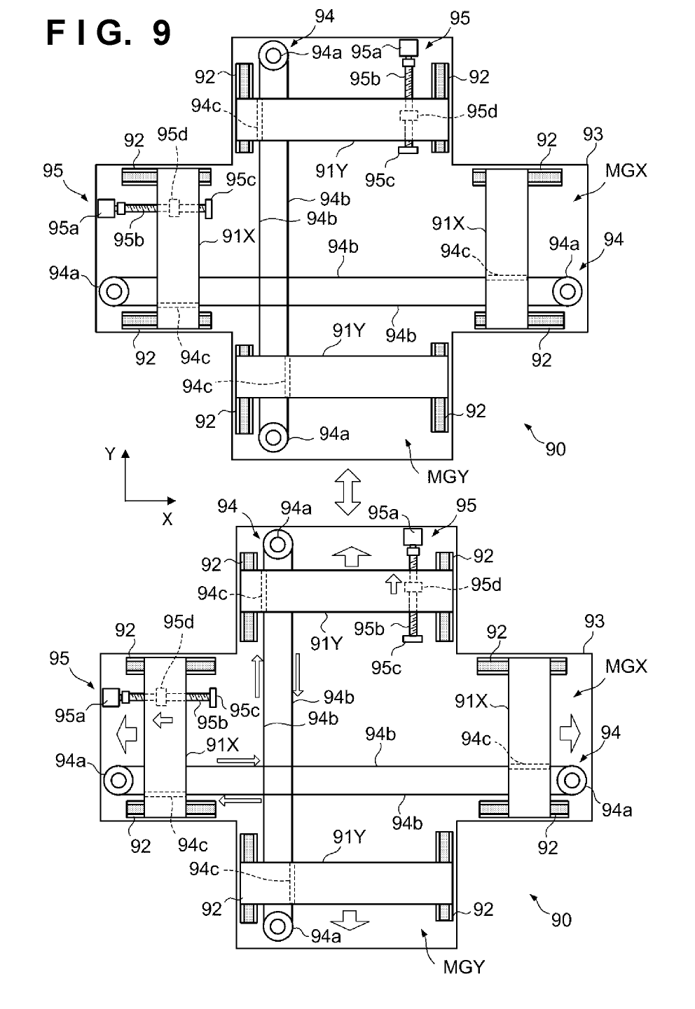

Each movement guide unit 90 will be described with reference to FIGS. 1, 2, and 9. FIG. 9 is a view for explaining the movement guide unit 90, showing two forms in which different intervals are set between moving base members 91X and between moving base members 91Y (to be referred to as moving base members 91 hereinafter when they are generically referred to).

The movement guide units 90 guide the movement of the periphery holding units 60 facing each other in the directions to approach and separate from each other. Since it is possible to adjust the interval between the periphery holding units 60 facing each other, it is possible to hold the periphery (the respective sides) of the substrate 1 in accordance with its size.

In this embodiment, each movement guide unit 90 includes a movement guide unit MGX, a movement guide unit MGY, and a common base member 93 on which the guide units are mounted. The base member 93 is a cruciform plate member in a planar view. Since the base member 93 is a common base member, the upper surface of the base member 93 can be used as a common reference surface at the time of assembly of the movement guide unit MGX and the movement guide unit MGY. This can improve the horizontal accuracy of the upper surfaces of the periphery mount portions 61 before and after the movement of the periphery holding unit 60. In addition, since the upper surfaces of the periphery mount portions 61 can be used as reference surfaces at the time of assembly of each periphery holding unit 60, it is possible to easily assemble the components and facilitate height positioning of the mount surfaces of the periphery mount portions 61 of each periphery holding unit 60.

The movement guide unit MGX causes the movement base members 91X to approach and separate from each other in the X direction. The movement guide unit MGY causes the movement base members 91Y to approach and separate from each other in the Y direction. The periphery holding unit 60 is mounted on each movement base member 91 through columnar support members 64.

The movement guide unit MGX includes guide members 92 which guide the sliding movement of the movement base members 91X in the X direction. The guide members 92 are provided on the two end portions of each movement base member 91X in the Y direction, extend in the X direction, and are fixed on the base member 93. The guide members 92 engage with slide portions provided on the lower surface of the movement base member 91X to guide the movement of the movement base member 91.

The movement guide unit MGX includes a belt power transmission mechanism 94 for interlocking the movement of each movement base member 91X. The belt power transmission mechanism 94 includes a pair of pulleys 94a which are rotatably supported on the base member 93 and spaced apart from each other in the X direction and an endless belt 94b wound around the pair of pulleys 94a. The movement base members 91X are fixed to the endless belt 94b through coupling members 94c. The fixed portions of the movement base members 91X relative to the endless belt 94b are portions which travel in different directions on the endless belt 94b. For this reason, the movement base members 91X move in opposite directions.

The movement guide unit MGX includes a driving mechanism 95 for moving the movement base members 91X along the guide members 92. Although the driving mechanism 95 of the movement guide unit MGX moves one of the movement base members 91X, the belt power transmission mechanism 94 moves both the movement base members 91X.

The driving mechanism 95 includes a motor 95a fixed to the base member 93, a ball screw 95b to be rotated and driven by the motor 95a, an axial support portion 95c which is fixed to the base member 93 and axially supports an end portion of the ball screw 95b, and a coupling member 95d. The ball screw 95b extends in the X direction. The coupling member 95d has a ball nut meshed with the ball screw 95b and is connected to the movement base member 91X. For this reason, when the motor 95a drives and rotates the ball screw 95b, the movement base member 91X moves. A sensor (not shown) such as an encoder, which detects the amount of rotation of the ball screw 95b, detects the positions of the movement base members 91X.

In this embodiment, in this manner, the driving of the motor 95a can automate the adjustment of the interval between the movement base members 91X, that is, the adjustment of the interval between the periphery holding units 60 mounted on the movement base members 91X. Although this embodiment uses the ball screw mechanism in this manner, it is possible to use another type of mechanism.

The arrangement of the movement guide unit MGY is the same as that of the movement guide unit MGX. That is, the movement guide unit MGY includes guide members 92 which guide the sliding movement of the movement base members 91Y in the Y direction. The guide members 92 are provided on the two end portions of each movement base member 91Y in the X direction, extend in the Y direction, and are fixed on the base member 93. The guide members 92 engage with slide portions provided on the lower surfaces of the movement base members 91Y to guide the movement of the movement base members 91Y.

The movement guide unit MGY includes a belt power transmission mechanism 94 for interlocking the movement of each movement base member 91Y. The belt power transmission mechanism 94 includes a pair of pulleys 94a which are rotatably supported on the base member 93 and spaced apart from each other in the Y direction and an endless belt 94b wound around the pair of pulleys 94a. The belt 94b of the movement guide unit MGX and the endless belt 94b of the movement guide unit MGY travel at positions shifted from each other in the Z direction to prevent interference between them.

The movement base members 91Y are fixed to the belt 94b through coupling members 94c. The fixed portions of the movement base members 91Y relative to the belt 94b are portions which travel in different directions on the endless belt 94b. For this reason, the movement base members 91Y move in opposite directions.

The movement guide unit MGY includes a driving mechanism 95 for moving the movement base members 91Y along the guide members 92. The driving mechanism 95 of the movement guide unit MGY has the same arrangement as that of the driving mechanism 95 of the movement guide unit MGX. However, a ball screw 95b extends in the Y direction. Letting the movement guide unit MGY include the driving mechanism 95 can automate the adjustment of the interval between the movement base members 91Y, that is, the adjustment of the interval between the periphery holding units 60 mounted on them.

In this embodiment, the collection unit 80 is mounted on each movement base member 91. With this structure, when the periphery holding units 60 move, the collection units 80 simultaneously move. This makes it possible to always locate the collection units 80 at the optimal positions relative to the periphery holding units 60 and cope with a plurality of sizes of substrates.

<Outer Conveyor 100>

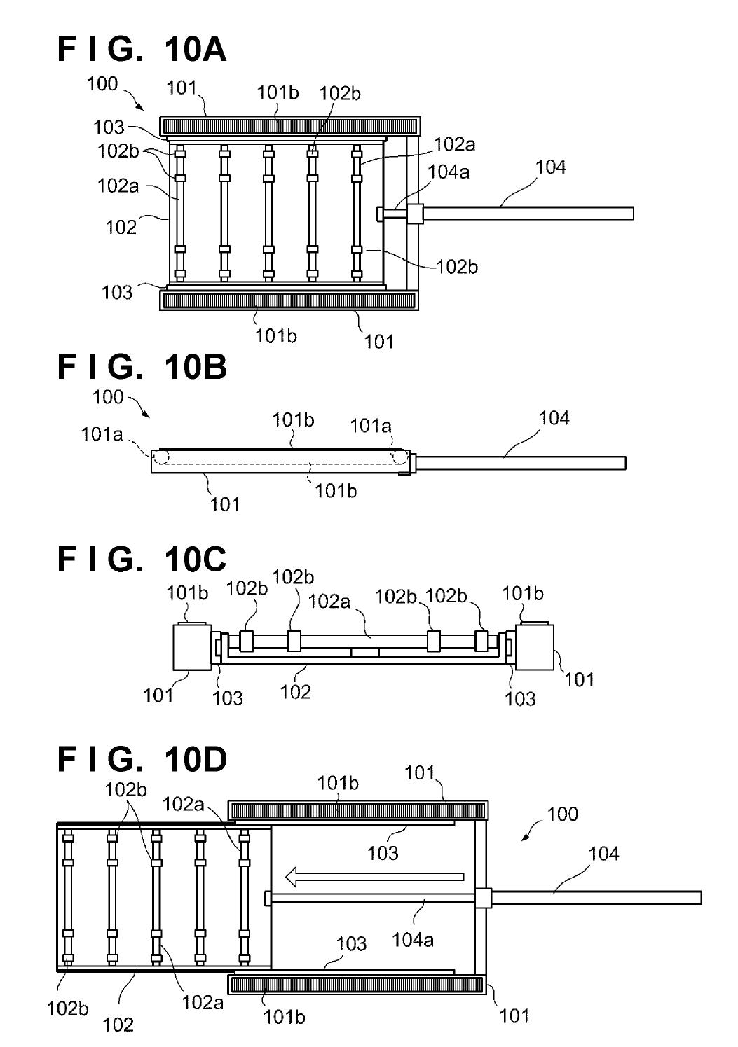

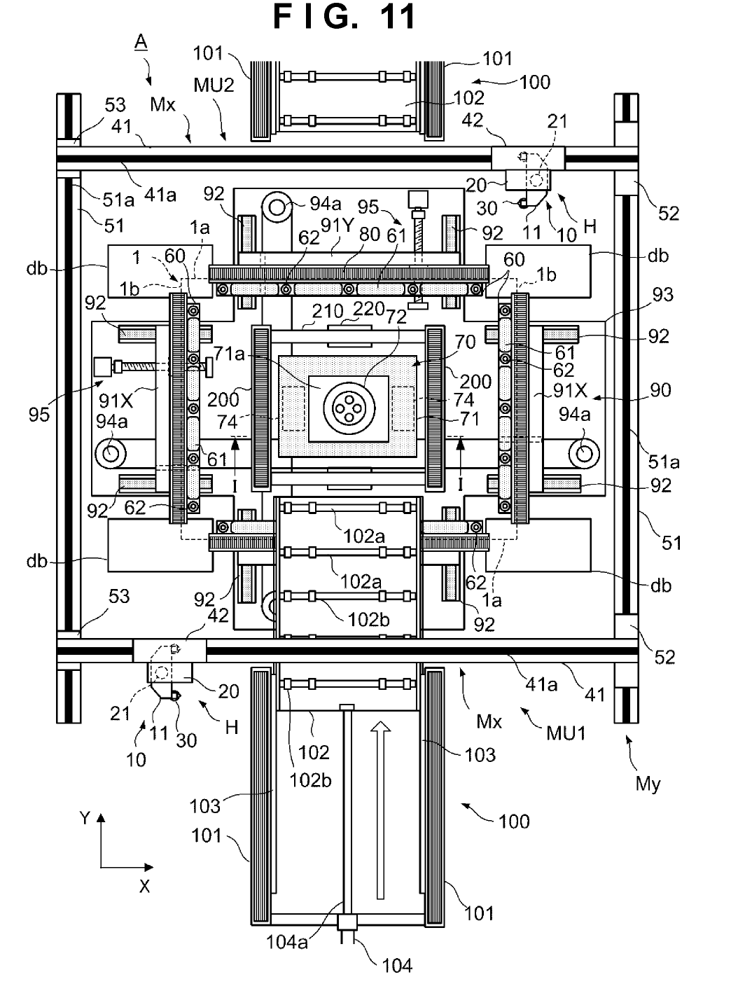

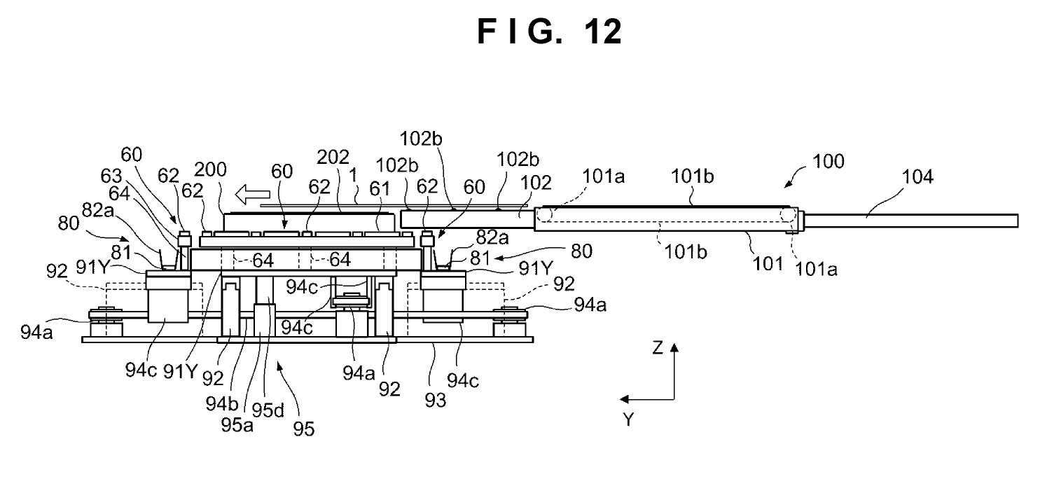

The outer conveyor 100 will be described with reference to FIGS. 1 and 10A to 12. FIG. 10A is a plan view of the outer conveyor 100. FIG. 10B is a side view of the outer conveyor 100. FIG. 10C is a front view of the outer conveyor 100. FIG. 10D is a view for explaining the operation of the outer conveyor 100. FIGS. 11 and 12 are views for explaining transfer operation for the substrate 1 between the center holding unit 70 and the outer conveyor 100.

As shown in FIG. 1, in this embodiment, the two outer conveyors 100 are provided separately from each other in the Y direction. Referring to FIG. 1, the outer conveyor 100 on the lower side is used to load the substrate 1 before trimming, and the outer conveyor 100 on the upper side is used to unload the substrate 1 after trimming. Note that FIG. 1 omits the illustration of part of both the outer conveyors 100.

Referring to FIGS. 10A to 10D, the outer conveyor 100 includes two rows of first conveyors 101 and a second conveyor 102 provided between them. The first conveyor 101 is a belt conveyor including a pair of pulleys 101a and an endless belt 101b wound around the pair of pulleys 101a. A driving unit (not shown) such as a motor drives and rotates one of the pair of pulleys 101a to make the belt 101b travel. The traveling direction of the belt 101b is the Y direction.

The second conveyor 102 includes the shaft bodies 102a and free rollers 102b. Guide members 103 are provided on the inner side surfaces of the first conveyors 101. The second conveyor 102 is supported by the conveyors 101 through the guide members 103, and can freely move back and forth in the same direction as the traveling direction of the belts 101b. FIG. 10A shows a case in which the second conveyor 102 is at the retract position. FIG. 10D shows a case in which the second conveyor 102 is at the entrance position. The second conveyor 102 is provided to change the convey distance of the first conveyors 101. At the entrance position, the second conveyor 102 forms a convey path continuous with the first conveyors 101. That is, the second conveyor 102 increases the convey distance that the substrate 1 can be conveyed by the driving force of the first conveyors 101. At the retract position, the second conveyor 102 is completely accommodated within the total length of the first conveyors 101, and hence does not increase the convey distance that the substrate 1 can be conveyed by the driving force of the first conveyors 101.

Each outer conveyor 100 includes an actuator 104 serving as a driving source for moving the second conveyor 102 back and forth. The actuator 104 is an air cylinder in this case, and moves the second conveyor 102 back and forth by moving a rod portion 104a.

As shown in FIG. 1, the first conveyors 101 are placed outside the area surrounded by the four periphery holding units 60, and need to convey the substrate 1 to the center holding unit 70 over the periphery holding unit 60. Note however that it is necessary to provide an empty space above the periphery holding units 60 for the sake of convenience in trimming operation by the cutting units 10.

This embodiment therefore includes the second conveyor 102, which is located at the entrance position only at the time of loading of the substrate 1. As shown in FIGS. 11 and 12, at the entrance position, the second conveyor 102 extends over the periphery holding unit 60 and forms a convey path continuous with the first conveyors 101. Upon completion of the loading of the substrate 1, the second conveyor 102 returns to the retract position outside the area surrounded by the periphery holding units. The second conveyor 102 operates in the same manner as described above when unloading the substrate 1.

<Center Holding Unit 70 and Inner Conveyor 200>

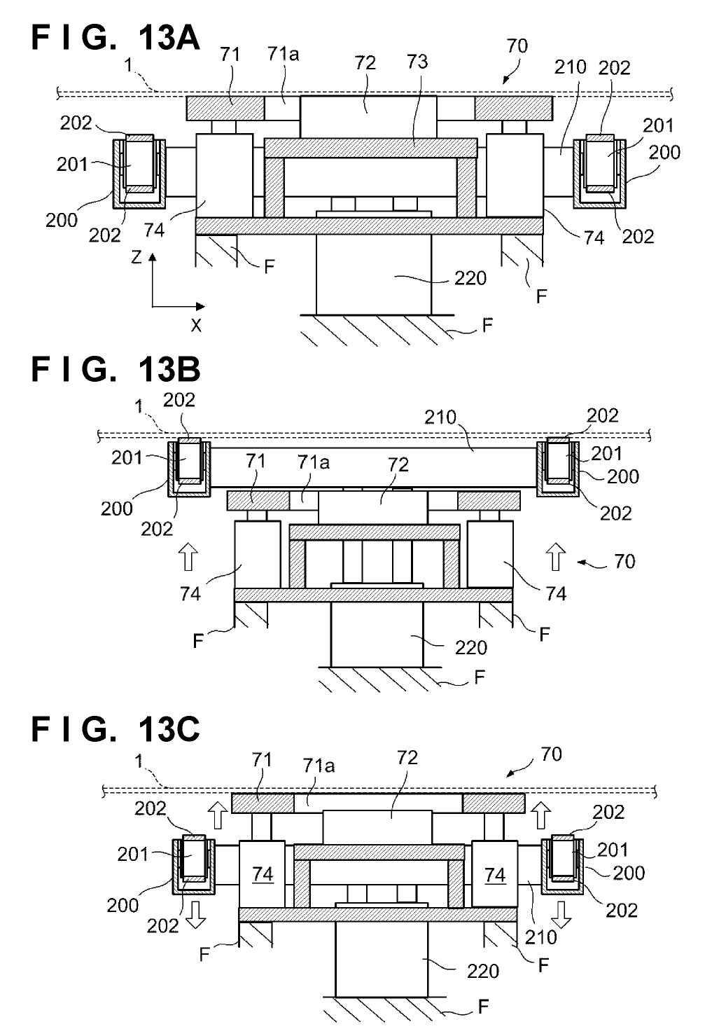

The center holding unit 70 and the inner conveyor 200 will be described with reference to FIGS. 1, 2, and 13A to 13C. FIG. 13A is a sectional view of the center holding unit 70 and inner conveyor 200 taken along a line III-III in FIG. 1. FIGS. 13B and 13C are views for explaining the operations of the center holding unit 70 and inner conveyor 200.

The periphery holding units 60 can satisfactorily hold the substrate 1. If, however, the held substrate has a large size, a central portion may go slack. This embodiment therefore includes the center holding unit 70 which holds the central portion of the substrate 1.

Referring to FIGS. 1 and 13A, the center holding unit 70 includes a plate-like center mount portion 71 on which the central portion of the substrate 1 is mounted. The upper surface of the center mount portion 71 is a level surface on which the substrate 1 is mounted. An opening portion 71a is formed in the central portion of the center mount portion 71. A center suction portion 72 which chucks the central portion of the substrate 1 is placed to face the opening portion 71a. The center suction portion 72 is a vacuum suction pad which holds the substrate 1 from its rear surface side, and is connected to a vacuum pump (not shown). The center suction portion 72 is permanently supported on the frame F through a support body 73.

Lifting devices 74 supported on the support body 73 move the center mount portion 71 up and down in the Z direction. The lifting devices 74 each can include a driving mechanism obtained by combining an air cylinder, a driving source such as a motor, and a mechanism such as a rack-pinion mechanism. FIG. 13A shows a case in which the center mount portion 71 is located at the descent position. In this case, the upper surface of the center mount portion 71 is flush with the upper surface of each periphery mount portion 61.

The inner conveyors 200 are provided in two rows. The convey direction of the both inner conveyors 200 is the same as that of the first conveyor 100 of the outer conveyor 100. Each inner conveyor 200 is a belt conveyor including a pair of pulleys 201 and an endless belt 202 wound around the pair of pulleys 201. A driving unit (not shown) such as a motor drives and rotates one of the pair of pulleys 201 to make the belt 202 travel. The traveling direction of the belt 202 is the Y direction.

The two inner conveyors 200 are coupled to each other through beam-like coupling members 210. Lifting devices 220 are placed between the coupling members 210 and the frame F to move the inner conveyors 200 up and down in the Z direction. Each lifting device 220 can include a driving mechanism obtained by combining an air cylinder, a driving source such as a motor, and a mechanism such as a rack-pinion mechanism. FIG. 13A shows a case in which the inner conveyors 200 are located at the descent positions. In this case, as shown in FIG. 13A, the convey surfaces of the inner conveyors 200 are lower in level than the upper surface of the center mount portion 71 at the descent position.

As shown in FIG. 1, the inner conveyors 200 are located in the area surrounded by the four periphery holding units 60 to transfer the substrate 1 between the outer conveyor 100 and the center holding unit 70. The operation at the time of loading of the substrate 1 will be described below.

As shown in FIG. 13B, first of all, the lifting devices 220 move the inner conveyors 200 to the ascent positions. In this case, as shown in FIG. 13B, the convey surfaces of the inner conveyors 200 are lower in level than the upper surface of the center mount portion 71 at the descent position. As described with reference to FIGS. 11 and 12, the second conveyor 102 of the outer conveyor 100 is moved to the entrance position, and the inner conveyors 200 and the first conveyors 101 are driven. A robot device or the like then conveys the substrate 1 as a trimming target onto the first conveyors 101. The substrate 1 is conveyed on the first conveyors 101, the second conveyor 102, and the inner conveyors 200 in the order named. A sensor (not shown) detects the position of the substrate 1 to control the amount of conveyance. This makes it possible to position the substrate 1 on the center holding unit 70.

Subsequently, the second conveyor 102 of the outer conveyor 100 returns to the retract position. As shown in FIG. 13C, the lifting devices 220 lower the inner conveyors 200. The lifting devices 74 lift the center mount portion 71 (or the center mount portion 71 stands by at the ascent position). In this case, the upper surface of the center mount portion 71 is higher in level than the upper surface of each periphery mount portion 61. In this manner, loading of the substrate 1 onto the center mount portion 71 is complete. Thereafter, the substrate 1 is positioned and held. However, this operation will be described later. Note that the substrate 1 is unloaded by using the outer conveyor 100 for unloading following the reverse procedure to that for loading operation.

<Controller>

A controller 300 which controls the cutting apparatus A will be described next. FIG. 6B is a block diagram of the controller 300. The controller 300 includes a processing unit 301 such as a CPU, a storage unit 302 such as a RAM, ROM, or hard disk, and an interface unit 303 which interfaces the processing unit 301 with an external device.

The processing unit 301 executes programs stored in the storage unit 302 and controls various types of actuators 307 based on the detection results obtained by various types of sensors 306. The various types of sensors 306 include sensors which detect the positions of the cutting units 10 and sensors and the like which detect the positions of the movement base members 91. The various types of actuators 307 include the motors 132a and 95a. An input unit 304 includes a keyboard and a mouse which accept instructions from an operator. A display unit 305 is an image display device which displays various kinds of information.

<Example of Operation>

The operation of trimming the cover sheet 2 by the cutting apparatus A will be described next. First of all, for operation in a step before trimming operation, the apparatus adjusts the intervals between the periphery holding units 60 facing each other in accordance with the size of the substrate 1 as a target. To adjust the intervals, the apparatus controls the motors 95a of the driving mechanisms 95 based on size information indicating the size of the substrate 1 so as to locate the periphery holding units 60 at the respective inner peripheral portions of the substrate 1.

Size information may be recognized by the controller 300 in accordance with an input from the input unit 304 or a command from a host computer communicatively connected to the controller 300. The storage unit 302 may store the position information of the periphery holding units 60 which correspond to size information in advance, and control the motors 95a based on the position information. Such an arrangement will help to further automate the adjustment of the intervals between the periphery holding units 60 facing each other.

Trimming operation will be described next. In this embodiment, the cutting unit 10 of the moving unit MU1 and the cutting unit 10 of the moving unit MU2 respectively take charge of the opposing sides of the substrate 1 to trim the cover sheet 2 with respect to the four sides of the substrate 1. The direction of the disc blade 14 (the intersection angle between a vertical plane including the sides 1a and 1b and the disc blade 14) is adjusted by the pivot angle (pivot amount) of the cutting unit 10 set by the pivoting/lifting unit 20, which is preferably set to an optimal value in advance. In addition, it is preferable to set the position of the abutment member 32 to an optimal value at the time of positioning by the abutment member 32. This embodiment is configured to store, in the storage unit 302 in advance by so-called teaching, the pivot angle (pivot amount) of the cutting unit 10 at the time of cutting, the data of a cutting start position corresponding to the size of the substrate 1, and the data of the position of the abutment member 32.

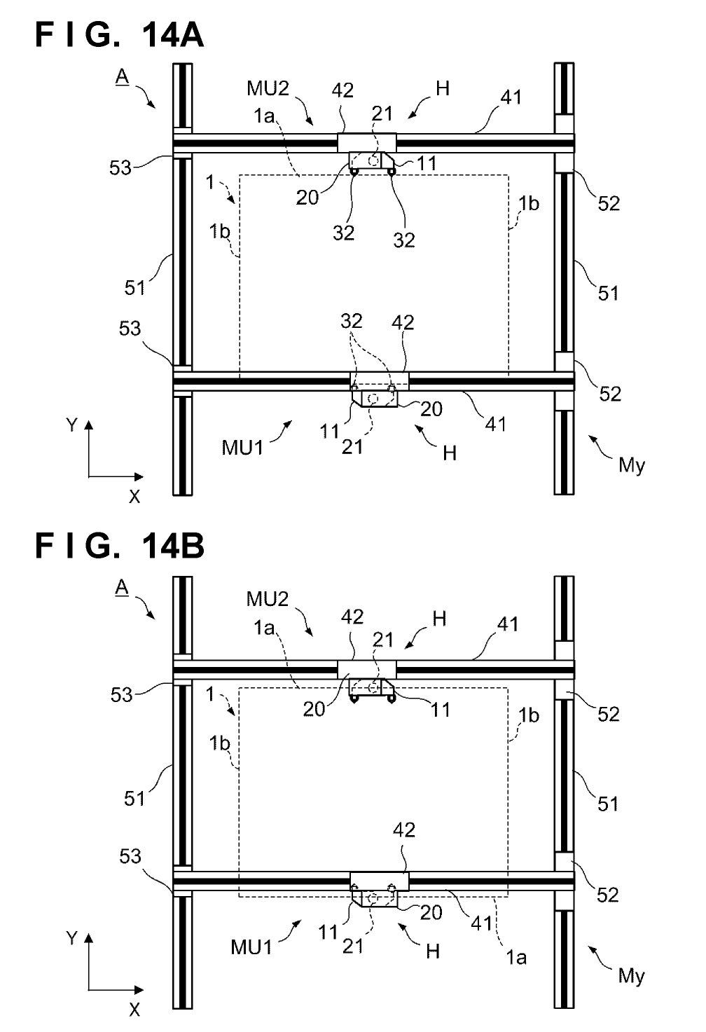

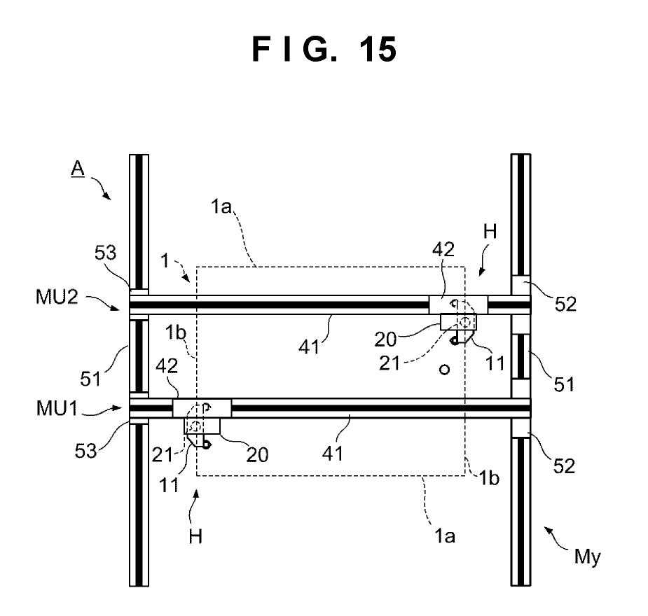

FIGS. 14A, 14B, and 15 are views for explaining teaching operation. FIG. 14A shows the setting of positions for positioning by the abutment members 32. FIG. 14B shows the setting of information associated with cutting of a cover sheet along the sides 1a of the substrate 1. FIG. 15 shows the setting of information associated with cutting of the cover sheet along the sides 1b of the substrate 1.

In either of the cases, the sample substrate 1 as a reference is positioned and held on the periphery holding units 60 and the center holding unit 70. The operator then manually makes the cutting units 10 pivot or move to locate them at the respective positions while the two head units H are moved to near the substrate 1.

In the case shown in FIG. 14A, the two abutment members 32 of the moving unit MU1 are made to abut against one side 1a of the substrate 1, and the two abutment members 32 of the moving unit MU2 are made to abut against the other side 1a. The storage unit 302 then stores position information at this time.

In the case in FIG. 14B or 15, the operator manually makes the cutting units 10 pivot or move to locate the disc blades 14 at the optimal cutting positions with respect to the sides 1a and 1b. The controller 300 then obtains optimal cutting positions (reference cutting positions) by performing sample cutting operation (reference cutting operation) upon matching the positions of the respective cutting units 10 and pivot amounts with the substrate and cover sheet to be cut, and stores the resultant data in the storage unit 302. As will be described later, in this embodiment, at the time of trimming along the sides 1a, the cutting units 10 are moved in one direction or the other direction in the X direction. Therefore, pivot amounts are set for the cutting units 10 in the respective cases. With the above teaching processing, the controller 300 completes setting of the pivot angles (pivot amounts) and positions of the cutting units 10 at the time of positioning and cutting.

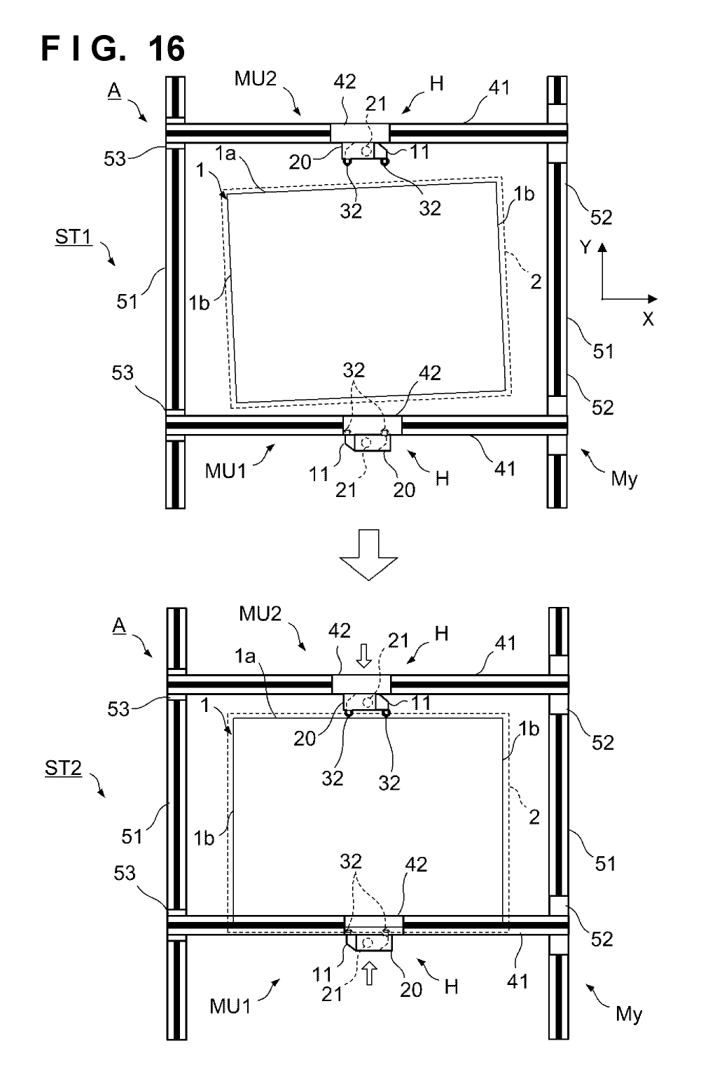

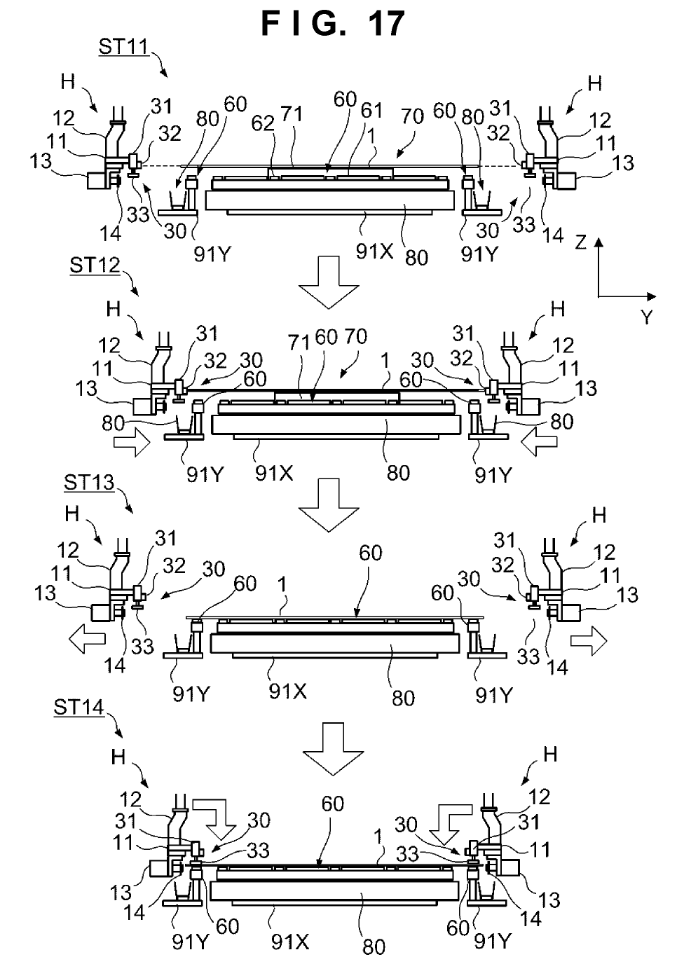

Actual examples of positioning operation and trimming operation will be described next with reference to FIGS. 16 to 21. An example of positioning operation for the substrate 1 covered by the cover sheet 2 will be described first with reference to FIGS. 16 and 17.

ST1 in FIG. 16 indicates a state in which the substrate 1 whose surface is covered by the cover sheet 2 is loaded onto the center mount portion 71, as shown in FIG. 13C. ST11 in FIG. 17 is a view of the main part of the cutting apparatus A in the state of ST1 in FIG. 16 when viewed from the X direction. In this state, the substrate 1 is not positioned and is mounted at a position shifted from the proper position. The periphery suction portions 62 and the center suction portion 72 are in a non-suction state. In this state, the substrate 1 can move horizontally on the center mount portion 71.

The head units H of the moving units MU1 and MU2 are spaced apart from the sides 1a of the substrate 1 in the Y direction and located at the initial positions set at the positions where they face each other through the substrate 1. At the initial positions, thereafter, the positions of the abutment members 32 in the X and Z directions are set at the positions based on position information for positioning set by teaching processing such that the substrate 1 is positioned by the abutment members 32 when the head units H are moved in the Y direction.

Subsequently, the apparatus moves the moving unit My to move the moving units MU1 and MU2 in directions to approach each other until the positions of the abutment members 32 in the Y direction are set to the positions based on the position information for positioning set by teaching processing (ST2 in FIG. 16, ST12 in FIG. 17). When the abutment members 32 abut against the sides 1a of the substrate 1 (in practice, through the cover sheet 2), the substrate 1 is positioned. In this embodiment, the abutment members 32 abut against the sides 1a of the substrate 1 at the midway portions of the sides 1a (almost the middle portions of the sides (middle portions)).

This embodiment is configured to perform positioning (centering) of the substrate 1 by making the abutment members 32 abut against the substrate 1 in this manner, and hence can position the substrate and efficiently cut the edge portions of the cover sheet 2 with a relatively simple arrangement. In addition, since the moving mechanisms for the abutment members 32 also serve as the mechanisms (the moving units Mx and My and the pivoting/lifting units 20) for moving the disc blades 14, it is not necessary to independently provide any moving mechanisms for moving the abutment members 32. This further implements simpler arrangements.

Upon completion of the positioning of the substrate 1, as indicated by ST13 in FIG. 17, the apparatus moves the moving units MU1 and MU2 in directions to separate them from each other, and lowers the center mount portion 71 (the state in FIG. 13A). With this operation, the substrate 1 is mounted on the center mount portion 71 and the periphery mount portions 61 of the periphery holding units 60.

Subsequently, as indicated by ST14 in FIG. 17, the apparatus moves the moving units MU1 and MU2 in directions to approach each other, and lower the head units H. The apparatus then causes the press members 33 to gently press the end portions of the substrate 1 against the periphery holding units 60. In this pressed state, the apparatus sets the periphery suction portions 62 and the center suction portion 72 in a suction state to hold the substrate 1. This maintains the state in which the substrate 1 is positioned at a predetermined position (cutting position). Causing the press members 33 to press the substrate 1 can prevent a chucking error due to a space which is produced between the substrate 1 and the periphery suction portions 62 and the center suction portion 72, in particular between the substrate 1 and the periphery suction portions 62, when the substrate 1 has slight distortion.

Subsequently, after moving the head units H upward and retracting the head units H (press members 33) from the substrate 1, the apparatus shifts to trimming (cutting) operation for the cover sheet 2. In this embodiment, in order to quickly shift from positioning operation to trimming operation, the apparatus starts cutting the cover sheet 2 from midway portions (almost the middle portions) of the sides 1a. This makes it possible to continuously perform operation from positioning operation to the start of cutting, thus allowing the mechanisms for moving the disc blades 14 to efficiently operate.

First of all, the apparatus moves the head units H to the cutting preparation positions. Thereafter, the apparatus starts rotating the disc blades 14 and moves the head units H in the Z direction. The apparatus then moves (presses) the disc blades 14 to the edge portion side of the cover sheet 2. At this time, the positions of the cutting units 10 in the X and Y directions and pivot angles (pivot amounts) are set to the positions and pivot angles based on the information for cutting which is set by teaching processing so as to locate the cutting units 10 at the cutting start positions at which the disc blades 14 start cutting the edge portions of the cover sheet 2. The apparatus then translates the head units H along sides of the substrate 1 (move the head units H in the X or Y direction) to cut the edge portions of the cover sheet 2 which protrude from the sides 1a of the substrate 1. The cut edge portions fall into the collection units 80 and are collected by the collection boxes db.

Note that making cutting start positions coincide with the positions of the cutting unit 10 in the X direction at the time of positioning of the substrate 1 by the abutment members 32 makes it unnecessary to move the cutting units 10 in the X direction when moving the cutting units 10 as indicated by ST13 in FIG. 17. This makes it possible to shift from positioning operation to trimming operation more quickly.

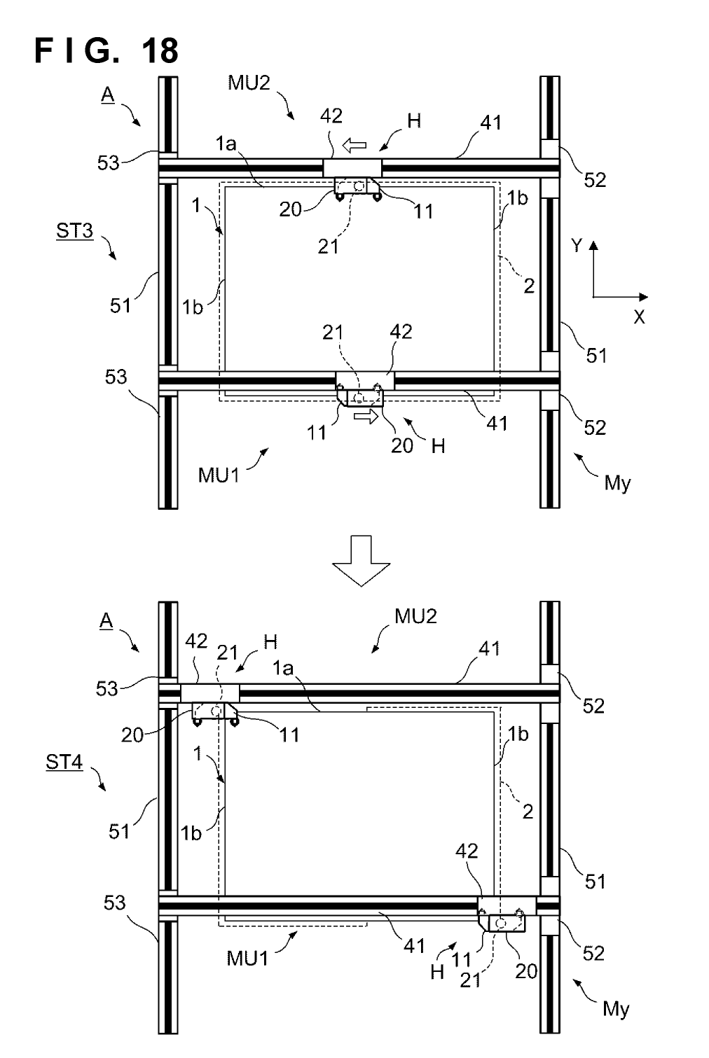

An example of actual trimming operation will be described next with reference to FIGS. 18 to 21. In this embodiment, the apparatus starts cutting the cover sheet 2 from midway portions (almost middle portions) of the sides 1a to quickly shift from positioning operation to trimming operation, as indicated by ST3 in FIG. 18. Owing to the function of the moving mechanisms Mx, the apparatus cuts edge portions of the cover sheet 2 along the sides 1a with the disc blades 14 while moving the two cutting units 10 in the opposite directions in the X direction. Since it is possible to simultaneously trim the cover sheet 2 with respect to two sides of the substrate 1, the operation efficiency improves. Note that it is possible to cut the edge portions of the cover sheet 2 in a zigzag form by not only linearly cutting the edge portions of the cover sheet 2 but also actuating the moving unit My.

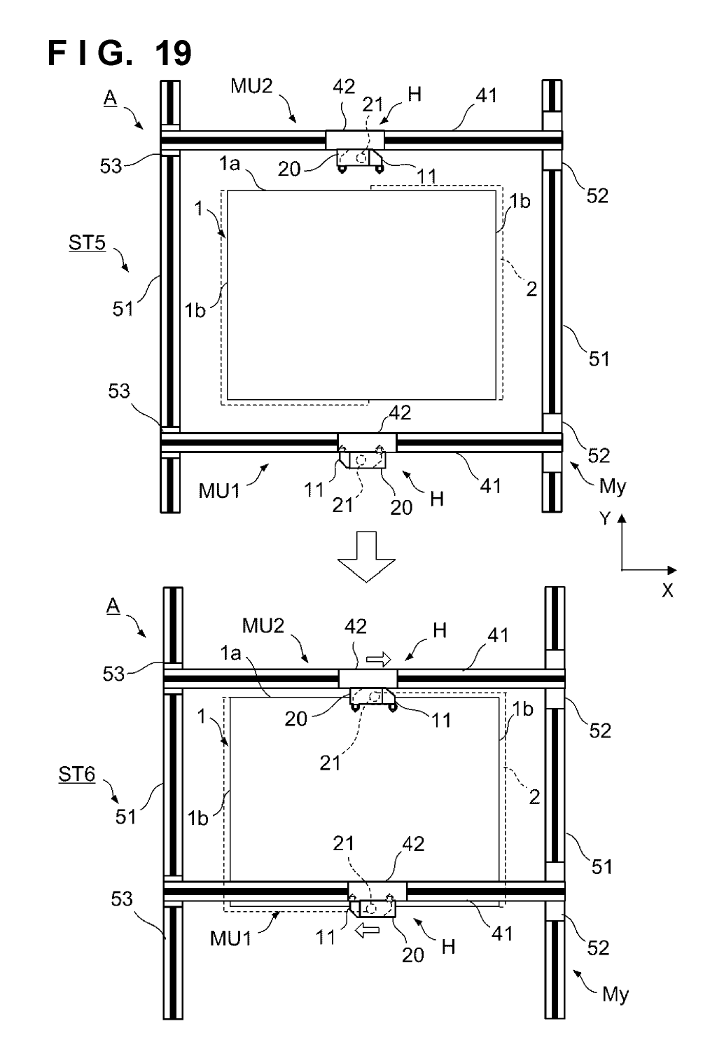

As indicated by ST4 in FIG. 18, when each cutting unit 10 reaches one end portion of the side 1a, almost half of an edge portion of the cover sheet 2 which protrudes from the side 1a is cut (first partial cutting step). Subsequently, the apparatus shifts to the operation of cutting the remaining half. First of all, owing to the functions of the moving mechanisms Mx and moving unit My, the apparatus moves the cutting units 10 to the cutting start positions indicated by ST6 through the preparation positions indicated by ST5 in FIG. 19, and starts cutting. At this time, owing to the function of the pivoting/lifting units 20, the apparatus sets the pivot angles of the cutting units 10 to the pivot angles set by teaching processing. It is also possible to move the cutting units 10 in the Z direction when moving them from the positions indicated by ST4 in FIG. 18 to the positions indicated by ST6 in FIG. 19.

Subsequently, owing to the function of the moving mechanisms Mx, the apparatus cuts edge portions of the cover sheet 2 along the sides 1a with the disc blades 14 while moving the two cutting units 10 in the opposite directions in the X direction. In this case, the apparatus cuts the remaining edge portions of the cover sheet 2 by moving the cutting units 10 in directions opposite to the cutting directions in the first partial cutting step, that is, to the other end portion of the side 1a (second partial cutting step).

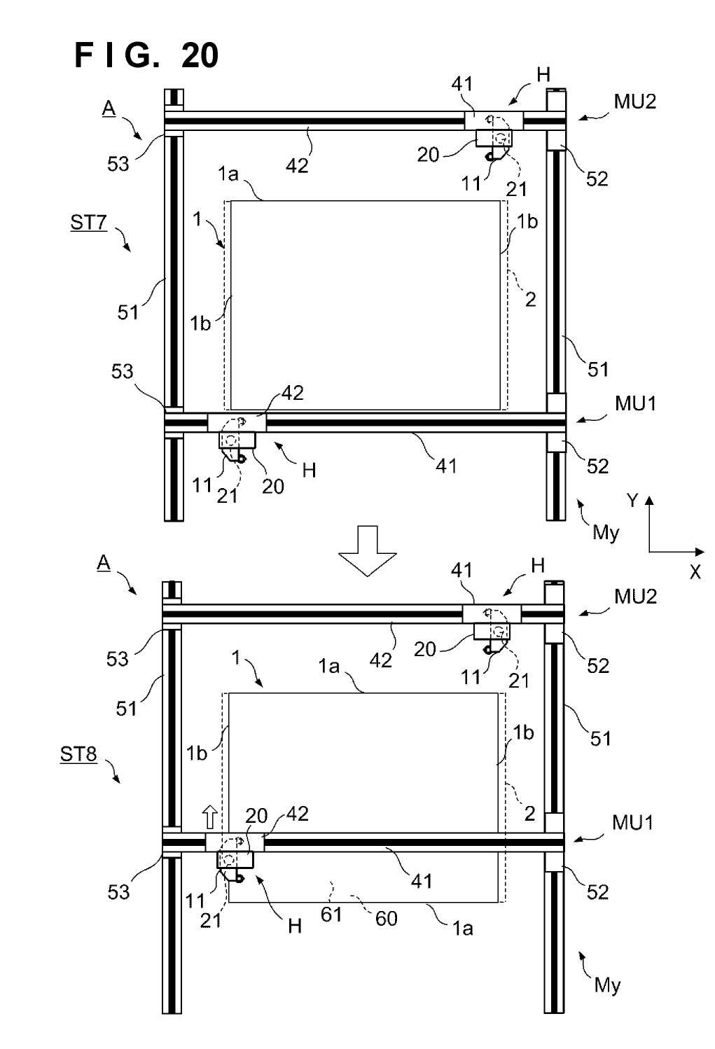

Upon completion of the cutting of the remaining edge portions of the cover sheet 2 along the sides 1a of the substrate 1, the apparatus shifts to the operation of cutting the edge portions of the cover sheet 2 along the sides 1b. First of all, the apparatus temporarily moves each cutting unit 10 away from the substrate 1, and makes each cutting unit 10 pivot to the pivot angle for the side 1b which is set by teaching, and moves one cutting unit 10 to the cutting start position as indicated by ST7 in FIG. 20, thus starting to cut the cover sheet.

When cutting edge portions of the cover sheet 2 which protrude from the sides 1b, the apparatus sequentially cuts the edge portions one by one so as to prevent the two driving sliders 52 from interfering with each other. ST7 in FIG. 20 indicates a case in which cutting operation starts from the moving unit MU1 side. The cutting unit 10 of the moving unit MU2 stands by at a position away from the substrate 1.

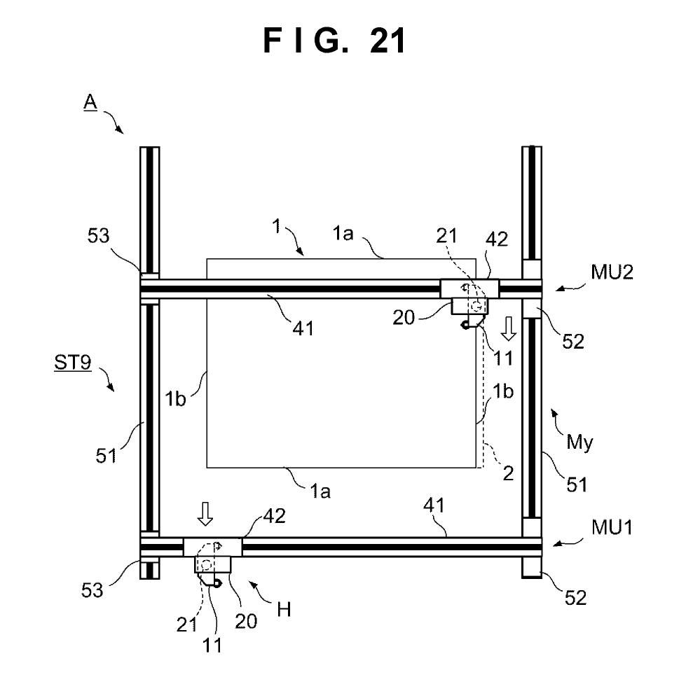

As indicated by ST8 in FIG. 20, owing to the function of the moving unit My, the apparatus moves the moving unit MU1 in one direction in the Y direction (upward in FIG. 20) to cut an edge portion of the cover sheet 2 which protrudes from the left side 1b in FIG. 20. Upon completion of cutting by the cutting unit 10 of the moving unit MU1, the apparatus moves the cutting unit 10 of the moving unit MU2 in the other direction in the Y direction (downward in FIG. 20), as indicated by ST9 in FIG. 21, to cut an edge portion of the cover sheet 2 which protrudes from the right side 1b in FIG. 21. At this time, the apparatus moves the moving unit MU1 in the other direction in the Y direction to a position where the moving unit MU1 is spaced apart from the substrate 1 and the two driving sliders 52 do not interfere with each other. It is possible to simultaneously or separately move the moving unit MU2 for cutting operation and the moving unit MU1 for retracting operation.

Upon completion of the cutting of the edge portion of the cover sheet 2 which protrudes from the right side 1b in FIG. 21, the apparatus terminates a series of trimming operation. Subsequently, the apparatus repeatedly performs similar trimming operation for other substrates 1. As described above, this embodiment can continuously performing positioning of the substrate 1 and cutting operation for the edge portions of the cover sheet 2, and hence can improve the operation efficiency. Obviously, it is only required to perform teaching processing once for the substrates 1 having the same size, and it is not necessary to perform teaching processing for each substrate 1. In addition, it is possible to start cutting operation with respect to the side 1b from a midway portion as in the case of cutting operation with respect to the side 1a.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-282375, filed Dec. 17, 2010, which is hereby incorporated by reference herein in its entirety.

What is claimed is:

1. A cutting apparatus which holds a rectangular substrate covered by a cover sheet and cuts an edge portion of the cover sheet which protrudes from a periphery of the rectangular substrate, comprising:
a periphery holding unit which includes a periphery mount portion on which a peripheral portion of the rectangular substrate is mounted and a periphery suction portion which chucks the periphery of the rectangular substrate, and is provided for each side of the rectangular substrate; and
a movement guide unit which guides movement of said periphery holding units facing each other in directions to approach and separate from each other.

2. The apparatus according to claim 1, wherein said movement guide unit comprises
a first movement guide unit configured to guide movement of a first pair of said periphery holding units facing each other in directions to approach and separate from each other, and
a second movement guide unit configured to guide movement of a second pair of said periphery holding units facing each other in directions to approach and separate from each other, and
the apparatus further comprises a base member on which said first movement guide unit and said second movement guide unit are mounted.

3. The apparatus according to claim 1, wherein said periphery mount portion comprises a tubular member which extends along the peripheral portion and horizontally supports the peripheral portion of the rectangular substrate from below, and
a plurality of said periphery suction portions are provided along a longitudinal direction of said tubular member.

4. The apparatus according to claim 1, further comprising a center holding unit comprising a center mount portion on which a central portion of the rectangular substrate is mounted and a center suction portion which chucks the central portion of the rectangular substrate.

5. The apparatus according to claim 1, wherein said movement guide unit comprises
a moving base member on which said periphery holding unit is mounted,
a guide member which guides sliding movement of said moving base member, and
a moving unit configured to move said moving base member along said guide member.

6. The apparatus according to claim 5, further comprising a control unit configured to control said moving unit, based on size information indicating a size of the rectangular substrate, so as to position said periphery holding units at each peripheral inside portion of the rectangular substrate.

7. The apparatus according to claim 1, further comprising a collection unit, placed outside said each periphery holding unit, configured to collect a cut edge portion of the cover sheet.

8. The apparatus according to claim 7, wherein said collection unit comprises
a conveyor which conveys the cut edge portion in a direction along a side of the rectangular substrate, and
a collection guide member which is provided around said conveyor and guides the falling edge portion cut from the cover sheet to said conveyor.

9. The apparatus according to claim 7, wherein said collection unit comprises
a collection guide member which is placed outside said each periphery holding unit and receives and collects the falling edge portion cut from the cover sheet, and
suction unit configured to communicate with said collection guide member and chuck the edge portion collected by said collection guide member.

10. The apparatus according to claim 1, further comprising a collection unit, placed outside said each periphery holding unit, configured to collect the cut edge portion,
wherein said movement guide unit comprises
a moving base member on which said periphery holding unit and said collection unit are mounted,
a guide member which guides sliding movement of said moving base member, and
driving unit configured to move said moving base member along said guide member.

11. The apparatus according to claim 4, further comprising
an outer conveyor which conveys the rectangular substrate between an outside of an area surrounded by said periphery holding units and an inside of the area, and
an inner conveyor which is placed in the area and transfers the rectangular substrate between said outer conveyor and said center holding unit.

12. The apparatus according to claim 11, wherein said outer conveyor comprises
a first conveyor placed outside the area surrounded by said periphery holding units, and
a second conveyor which extends over said periphery holding unit and is retractably provided between an entrance position forming a convey path continuous with said first conveyor and a retract position outside the area surrounded by said periphery holding units.

13. The apparatus according to claim 11, further comprising lifting unit configured to move at least one of said inner conveyor and said center holding unit up and down.
